(19) United States
(12) Patent Application Publication
(10) Pub. No.: US 2006/0182577 A1
(43) Pub. Date: Aug. 17, 2006

(54) Loading, unloading and refrigeration apparatus for refrigerated trailers

(76) Inventor: Anthony D. Orlando, Vernon Hills, IL (US)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 11/038,864

(22) Filed: Jan. 19, 2005

(51) Int. Cl. B60P 1/00

(52) U.S. Cl. 414/529

(57) ABSTRACT

Loading and unloading apparatus for a refrigerated trailer including a floor with a plurality of ribs extending longitudinally along the floor of the refrigerated trailer with a gap between adjacently disposed ribs, a sub floor disposed over the floor and the longitudinally extending ribs; a plurality of roller tracks disposed on the sub floor, the roller tracks extending longitudinally in the trailer and spaced apart from each other and a plurality of sleepers, the sleepers disposed longitudinally in the trailer and generally parallel with the roller tracks, with at least one of the plurality of sleepers disposed between adjacently disposed roller tracks. Preferably, a refrigeration unit has bifurcated ducts located along the ceiling adjacent to the sidewalls to preserve ceiling height.

### FIELD OF THE INVENTION

The present invention relates generally to apparatus for the handling of cargo, and more particularly apparatus for loading and unloading of refrigerated trailers. The present invention also relates to refrigeration apparatus for refrigerated trailers.

### BACKGROUND OF THE INVENTION

Roller systems have previously been employed in trailers of the type that are commonly called semi-trailers that are attached to, and moved by, semi-trucks. Such roller systems are typically used to move cargo that is placed on pallets, skids, containers, or the like. For example, U.S. Pat. No. 4,089,399 to Webb discloses pneumatically actuated roller tracks for load handling. These roller tracks include a plurality of rollers that can be pneumatically actuated by an inflatable bladder to rise partially above the top surface of the track. Loads can then be moved along the raised rollers to a desired position in the trailer. When the bladder is deflated, the rollers will retract into the track below the top surface. The load then rests upon the top surface of the roller track and on adjacent surfaces of the floor in the trailer.

Such roller tracks have previously been used in the floors of un-refrigerated semi-trailers. However, such roller tracks have not been employed in refrigerated semi-trailers. Refrigerated trailers are commonly used to haul cargo that needs refrigeration, such as many types of foods, pharmaceuticals, flowers and the like. These refrigerated trailers commonly have a corrugated floor with a plurality of ribs extending the length of the trailer. For example, FIG. 1 illustrates a cross-section of the floor of a typical refrigerated trailer, with the cross-section taken transversely. Each of the ribs may be about two inches in height with a gap, also about two inches, disposed between adjacent ribs. Typically, these ribs may be fabricated or formed from aluminum or from aluminum sheet material. The centers of the ribs may be hollow and may be filled with an insulation material, such as Styrofoam insulation. Such insulation material may also be disposed below the ribs and in other portions of the floor. Of course, insulation material is also disposed in the sidewalls and in the ceiling of refrigerated trailers.

These ribs in the floor of the refrigerated trailers support the loads placed thereon, while the gaps between the ribs provide a path for drainage of any moisture generated by the refrigeration system or released by the cargo. These gaps also provide ventilation paths for refrigerated air under the bottom surface of the pallets or skids placed on the floor of the trailer. Thus, a container may sit on the ribbed floor and the gaps between the ribs will facilitate cooling of the underside of the container.

It is known in the refrigerated trailer industry that this ribbed floor should not be punctured. Otherwise, the refrigeration qualities or characteristics of the trailer may be compromised by air leakage. Furthermore, a puncture in the floor may also cause moisture drainage to infiltrate the insulation, thereby reducing the effectiveness of the insulation.

For these various reasons, roller tracks, such as those described above, have not been used in refrigerated trailers. However, there has been a long felt need for roller systems in refrigerated trailers that would facilitate the loading and unloading of cargo.

Prior art refrigeration trailers also typically have a ventilation duct that is centrally and internally located along the ceiling for most of the length of the trailer to deliver refrigerated air to the rear of the trailer. This centrally located ventilation duct limits the effective floor to ceiling height in refrigerated trailers.

A general object of the present invention is to provide a refrigerated trailer with a roller system to assist in loading and unloading of cargo.

Another object of the present invention is to provide for more effective ventilation for the refrigeration system in a refrigerated trailer and to provide a higher floor to ceiling height along the central interior area of refrigerated trailers.

A further object of the present invention is to provide a ventilation system for a refrigerated trailer that maintains floor to ceiling height when a roller system is installed in the floor of a refrigerated trailer.

Yet another object of the present invention is to provide a floor for a refrigerated trailer that facilitates loading and unloading of cargo directly onto, or off of, a conveyor system.

A still further object of the present invention is to achieve greater efficiency in loading and unloading of refrigerated trailers.

### SUMMARY OF THE INVENTION

This invention is directed to loading and unloading apparatus for a refrigerated trailer including a floor with a plurality of ribs extending longitudinally along the floor of the refrigerated trailer with a gap between adjacently disposed ribs, a sub floor disposed over the floor and the longitudinally extending ribs; a plurality of roller tracks disposed on the sub floor, the roller tracks extending longitudinally in the trailer and spaced apart from each other and a plurality of sleepers, the sleepers disposed longitudinally in the trailer and generally parallel with the roller tracks, with at least one of the plurality of sleepers disposed between adjacently disposed roller tracks. The roller tracks are pneumatically actuated to raise rollers disposed in the roller tracks above the top surface of the roller tracks for loading of cargo into the refrigerated trailer. The rollers disposed in the roller tracks will recess below the top surface of the roller tracks when the pneumatic pressure is released such that the cargo rests upon the top surface of the roller tracks.

The sub floor may consist of sheet metal, with the sheet metal having a thickness in the range of about ⅛ inch or greater. The refrigerated trailer further includes upstanding sidewalls attached to the floor, the sidewalls having reinforced panels disposed near the floor, and the sub floor is attached to the reinforced panels.

The invention is further directed to a refrigerated trailer, including a floor, the floor including a plurality of ribs extending longitudinally along the floor of the refrigerated trailer with a gap between adjacently disposed ribs, a pair of upstanding sidewalls attached to the floor at opposite sides of the floor; a ceiling attached to upper portions of the sidewalls, a sub floor disposed over the floor and the longitudinally extending ribs, a plurality of roller tracks disposed on the sub floor, the roller tracks extending longitudinally in the trailer and spaced apart from each other and a plurality of sleepers, the sleepers disposed longitudinally in the trailer and generally parallel with the roller tracks, with at least one of the plurality of sleepers disposed between adjacently disposed roller tracks.

Such a refrigerated trailer further includes roller tracks that are pneumatically actuated to raise rollers disposed in the roller tracks above the top surface of the roller tracks for loading of cargo into the refrigerated trailer and that recess below the top surface of the roller tracks when the pneumatic pressure is released such that the cargo rests upon the top surface of the roller tracks. The sub floor of the refrigerated trailer consists of sheet metal, preferably with a thickness in the range of about ⅛ inch (0.32 cm) or greater. The refrigerated trailer may further include upstanding sidewalls that have reinforced panels disposed near the floor, with the sub floor attached to the reinforced panels.

Preferably, the refrigerated trailer further includes a refrigeration unit and a pair of ventilation ducts in communication with the refrigeration unit to provide refrigerated air from the refrigeration unit to the rear of the trailer, with one of the pair of ventilation ducts disposed along the ceiling adjacently to one sidewall of the trailer and the other of the pair of ventilation ducts disposed along the ceiling adjacently to the other sidewall of the trailer to provide maximum floor to ceiling height in a central area of the refrigerated trailer.

Yet another aspect of the present invention includes a refrigeration system for a refrigerated trailer, the refrigeration system including a refrigeration unit and a pair of ventilation ducts in communication with the refrigeration unit to provide refrigerated air from the refrigeration unit to the rear of the trailer, with one of the pair of ventilation ducts disposed along the ceiling adjacently to one sidewall of the trailer and the other of the pair of ventilation ducts disposed along the ceiling adjacently to the other sidewall of the trailer to provide maximum floor to ceiling height in a central area of the refrigerated trailer.

### BRIEF DESCRIPTION OF THE DRAWINGS

The invention, together with its objects and the advantages thereof, may best be understood by reference to the following description taken in conjunction with the accompanying drawings, in which like reference numerals identify like elements in the figures, and in which:

FIG. 1 illustrates of the floor of a prior art refrigerated trailer taken in transverse cross-section;

FIG. 2 is a transverse cross-sectional view of the floor of a refrigerated trailer with a roller track bed installed thereover in accordance with the present invention;

FIG. 3 is a similar transverse cross-sectional view of the floor of a refrigerated trailer with a roller track bed installed thereover, similar to that of FIG. 2, but taken in perspective;

FIG. 4 is a rear perspective view of a refrigerated semi-trailer with the rear doors opened or removed to illustrate ventilation ducts of the ventilation system disposed along the ceiling and adjacent to the upper sidewalls of the trailer, also in accordance with the present invention;

FIG. 5 is a transverse cross-sectional view of the floor of a refrigerated trailer with a roller track bed installed thereover, similar to that of FIG. 2, but enlarged to illustrated further details thereof;

FIG. 6 is a front perspective view of the refrigerated semi-trailer shown in FIG. 5 further illustrating the ventilation ducts of the refrigeration system disposed along the ceiling and adjacent to the upper sidewalls of the trailer; and

FIG. 7 illustrates a refrigerated semi-trailer with dual level floors, with the rear floor providing a greater floor to ceiling height than in the trailer shown in FIGS. 5-6, and which may also utilize the improved roller system and refrigeration system of the present invention.

### DESCRIPTION OF THE PREFERRED EMBODIMENTS

It will be understood that the invention may be embodied in other specific forms without departing from the spirit thereof. The present examples and embodiments, therefore, are to be considered in all respects as illustrative and not restrictive, and the invention is not to be limited to the details given herein.

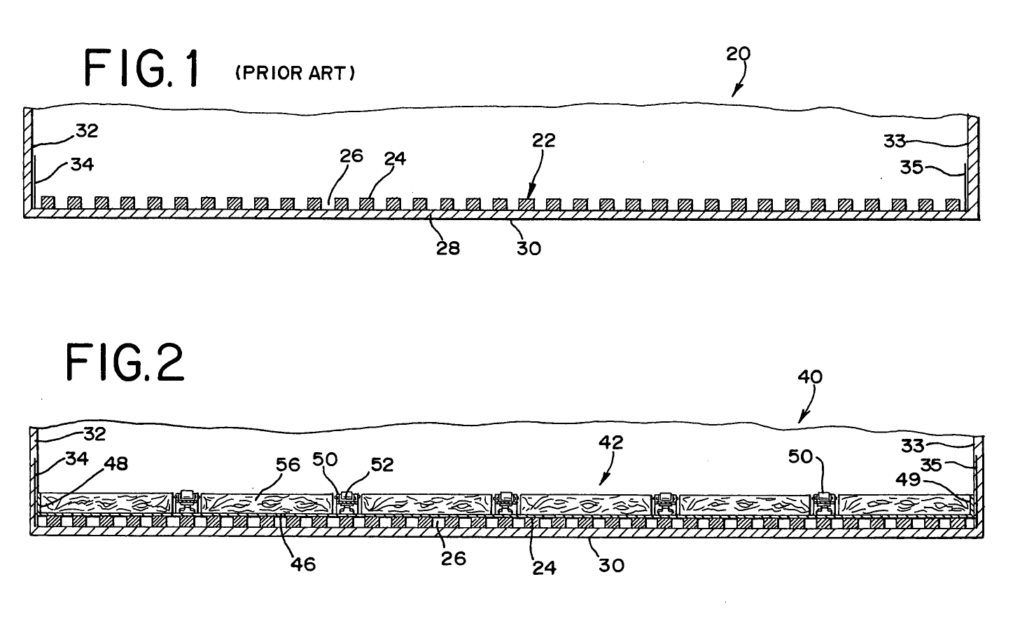

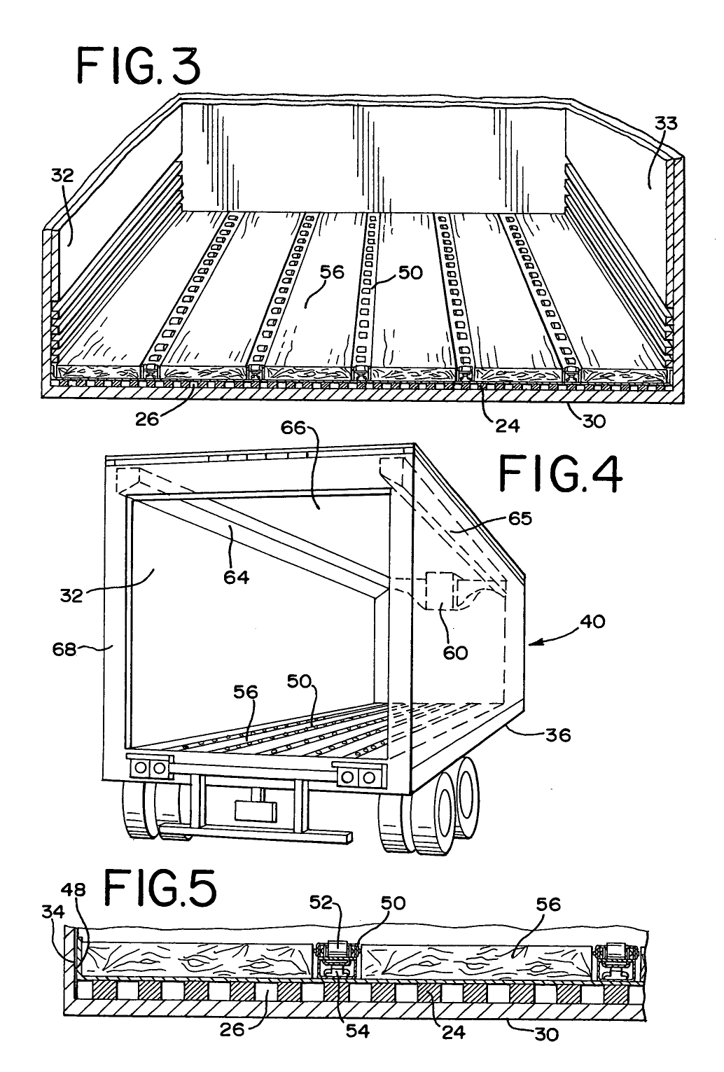

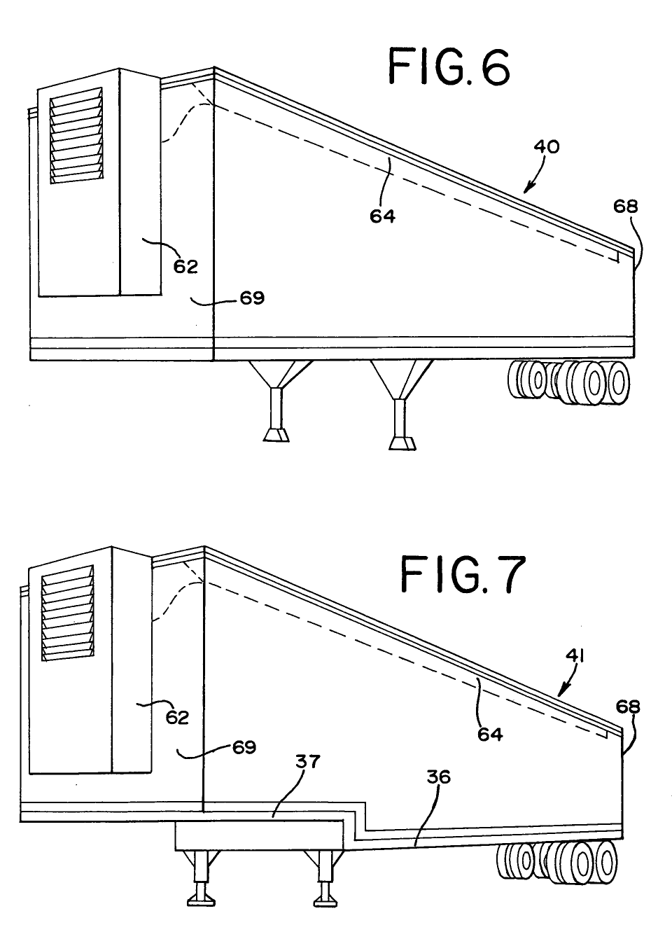

With reference to the drawing Figures, FIG. 1 illustrates a transverse cross-sectional view of a prior art floor, generally designated 22, disposed in a lower portion of a refrigerated trailer, generally designated 20. Floor 22 typically consists of a plurality of spaced-apart ribs 24 that generally extend longitudinally the length of floor 22. For example, ribs 24 may each be about 2 inches (about 5 cm) by 2 inches in cross-sectional dimension with a gap 26 of about 2 inches (about 5 cm) in width disposed between adjacent ribs 24. Gaps 26 permit refrigerated air to flow underneath any skids, pallets, containers, or the like, that set upon the upper surface of the ribs 24, thus keeping the underside of the pallet or container refrigerated. Gaps 26 also permit any moisture drainage to flow underneath the pallets or containers, thereby also keeping excess moisture from being absorbed by the pallet or container. Ribs 24 are supported by a floor portion 30 of the refrigerated trailer and ribs 24 may be an integral part of the upper surface of floor portion 30. For example, the ribs 24 may be formed from aluminum sheet material, which also provides gaps 26 therebetween and also forms the upper surface of floor portion 30. Usually, the ribs 24 and floor portion 30 are hollow and contain insulation 28 therein, such as Styrofoam insulation or the like.

Floor portion 30 of trailer 20 is disposed between and attached or secured to spaced-apart and upstanding sidewalls 32 and 33. Sidewalls 32-33 are also typically hollow and contain an insulating material. The lower portions of sidewalls 32-33 typically include reinforced panels 34 and 35 that are constructed of a thicker grade of aluminum shielding or armor to prevent damage to sidewalls 32-33 by fork lifts or other loading apparatus. These reinforced panels 34-35 also assist in preventing damage to sidewalls 32-33 due to movement of pallets or containers during shipment.

Such prior art refrigerated trailer construction, while suitable for refrigeration purposes, makes it difficult to load and unload cargo. For example, heavier cargo coming off of a conveyor cannot typically be loaded directly onto such a refrigerated trailer floor. Even lower weight items are difficult to load onto the floor of such a refrigerated trailer, especially directly to or from a conveyor. Conveyor systems are frequently used in the handling of cargo. For example, in airports, conveyor systems are used to handle, sort and load and unload cargo from airplanes.

FIG. 2 illustrates an improved refrigerated trailer, generally designated 40, with a bed, generally designated 42, constructed in accordance with the present invention. FIG. 2, like FIG. 1, is a transverse cross-sectional view of the lower portion of the refrigerated trailer 40. It will be noted that bed 42 in FIG. 2 utilizes some common elements of the floor 22 in FIG. 1. For example, bed 42 may include ribs 24, with gaps 26 therebetween, and floor portion 30. Sidewalls 32-33, with reinforced panels 34-35, are similarly attached to bed 42. In addition, bed 42 utilizes a sub floor 46 that lies over and upon ribs 24. Sub floor 46 may be any suitable rigid material, such as a heavier grade of sheet metal. For example, aluminum sheet or steel sheet of approximately ⅛ inch (about 3.2 mm) or greater thickness may provide sufficient rigidity for the sub floor. Preferably, sub floor 46 is about ¼ inch (about 6.4 mm) thick. Sub floor 46 may have side edges 48 and 49 that are formed at an upward right angle and disposed alongside the reinforced panels 34-35, respectively. Alternatively, sub floor 46 may have edges that terminate near reinforced panels 34-35, without the right angle side edges 48-49. That is, sub floor 46 may also be generally planar. If desired sub floor 46 may be provided with apertures therethough at various locations to permit drainage of any moisture through sub floor 46 to the gaps 26 between ribs 24. Alternatively, the front and back ends of sub floor 46 may be spaced from other structure, such as the rear doors, to permit moisture to drain down into the gaps 26.

Preferably, sub floor 46 is not secured to the ribs 24, such as by threaded fasteners, which could permit moisture to permeate into the insulation in or about the ribs and into the insulation in floor portion 30. Instead, edges 48 and 49 of sub floor 46 may be spot welded at spaced intervals to the reinforced panels 34-35, respectively. If sub floor 46 is planar, without the right angle edges 48-49, those edges of the sub floor nearest the reinforcing panels 34-35 may be welded directly to the reinforcing panels.

As further shown in FIG. 2, a plurality of pneumatically actuated roller tracks 50 preferably extend longitudinally in the bed 42 at spaced intervals from each other. For example, roller tracks 50 may be spaced about 12 to 18 inches (about 30 cm to 45 cm) apart. However, the spacing may be dependent upon the particular application and may be varied to suit the particular needs.

Such roller tracks are commercially available from the Hydraroll Division of Joloda Ltd. in Liverpool, England. These roller tracks have an internal pneumatic bladder 54 (FIG. 5) that, when pressurized, will raise the rollers 52 above the top surface of the roller track and above the top surface of bed 42 to facilitate rolling movement of a pallet, container, or the like, in the direction of the track, namely, into or out of the refrigerated trailer 40. When pneumatic pressure is removed from the bladder, the rollers 52 recess into the roller track below the surface of the bed 42 and the pallet or container rests on the top surface of bed 42, and is in frictional engagement therewith. Such frictional engagement may be sufficient to secure many types of loads during transit. However, securing straps, or the like, may also be used to secure the pallets or containers after loading.

Disposed between roller tracks 50 are spacers or sleepers 56. Sleepers 56 may be of any rigid material suitable for the bed 42. For example, sleepers 56 may be of wood. Preferably, sleepers 56 are of a thickness that provides a relatively flush surface with top surface of roller tracks 50 when the rollers 52 are recessed into the tracks.

Without the present invention, it has typically been necessary to use an un-refrigerated trailer with a roller bed to transfer the items from the conveyor system at an airport and to transport the items to a local trucking terminal. The items are then unloaded at the local trucking terminal and reloaded by a forklift or the like onto a refrigerated trailer for transport to the end destination, or temporarily kept in a refrigerated area in the trucking terminal. At the end destination, the items may again be unloaded at a local trucking terminal by a forklift or the like and reloaded onto a local delivery truck for delivery to the end destination.

With the loading and unloading system of the present invention, a refrigerated trailer can directly load or unload onto a conveyor system, such as at an airport, or other location. Thus, the transportation of many items may be accomplished by directly loading the cargo onto the refrigerated trailer and transporting the cargo to the next or end destination. At the end destination, the cargo may be rolled out of the refrigerated trailer onto another conveyor system. Thus, the intermediate steps of utilizing an un-refrigerated truck or trailer and the steps of unloading and reloading at local trucking terminals may be completely eliminated. Furthermore, the cargo remains refrigerated from the time that it is loaded from the conveyor system at the airport until it is delivered to the end destination. For example, continual refrigeration is needed or required for certain types of cargo, such as pharmaceuticals or the like.

It will be appreciated that the installation of the sub floor 46, roller tracks 50 and sleepers 56 over the original floor 22 in FIG. 1 increased the height of the bed 42 by about 2 to 3 inches (about 5 to 7.5 cm). This correspondingly decreases the effective floor to ceiling height by the same amount. Prior art refrigerated trailers typically have a single ventilation duct that delivers refrigerated air from a refrigeration unit 62 to the rear end 68 of the trailer 40, with the ventilation duct centrally located along the ceiling.

In accordance with another aspect of the present invention, and as best seen in FIGS. 4 and 7-8, a ventilation duct 60 from a refrigeration unit 62 is bifurcated into two separate ducts 64 and 65 that extend along the ceiling 66 of trailers 36 and 38 adjacent to sidewalls 32-33, respectively. This permits maximum use of the available floor to ceiling height in the central area of the trailer and preserves much or all of the floor to ceiling height in or near the center of the trailer that is otherwise lost due to the single centrally located ventilation duct of the prior art. Preferably, ventilation ducts 64-65 terminate short of the rear end of trailers 36 or 38 to provide effective distribution of refrigerated air at the rear of the trailer.

While particular embodiments of the invention have been shown and described, it will be obvious to those skilled in the art that changes and modifications may be made therein without departing from the invention in its broader aspects.

1. Loading and unloading apparatus for a refrigerated trailer, said loading and unloading apparatus comprising:
a floor, said floor including a plurality of ribs extending longitudinally along the floor of the refrigerated trailer with a gap between adjacently disposed ribs;
a sub floor disposed over said floor and said longitudinally extending ribs;
a plurality of roller tracks disposed on the sub floor, the roller tracks extending longitudinally in the trailer and spaced apart from each other; and
a plurality of sleepers, said sleepers disposed longitudinally in the trailer and generally parallel with said roller tracks, with at least one of said plurality of sleepers disposed between adjacently disposed roller tracks.

2. The loading and unloading apparatus in accordance with claim 1 wherein said roller tracks are pneumatically actuated to raise rollers disposed in the roller tracks above the top surface of the roller tracks for loading of cargo into the refrigerated trailer.

3. The loading and unloading apparatus in accordance with claim 2 wherein said rollers disposed in the roller tracks recess below the top surface of the roller tracks when the pneumatic pressure is released such that the cargo rests upon the top surface of the roller tracks.

4. The loading and unloading apparatus in accordance with claim 1 wherein said sub floor consists of sheet metal.

5. The loading and unloading apparatus in accordance with claim 4 wherein said sheet metal has a thickness in the range of about ⅛ inch (0.32 cm) to about ½ inch (1.27 cm).

6. The loading and unloading apparatus in accordance with claim 4 wherein said refrigerated trailer further comprises upstanding sidewalls attached to said floor, said sidewalls having reinforced panels disposed near the floor, and said sub floor is attached to said reinforced panels.

7. A refrigerated trailer, said refrigerated trailer comprising:
a floor, said floor including a plurality of ribs extending longitudinally along the floor of the refrigerated trailer with a gap between adjacently disposed ribs;
a pair of upstanding sidewalls attached to said floor at opposite sides of said floor;
a ceiling attached to upper portions of said sidewalls;
a sub floor disposed over said floor and said longitudinally extending ribs;
a plurality of roller tracks disposed on the sub floor, the roller tracks extending longitudinally in the trailer and spaced apart from each other; and
a plurality of sleepers, said sleepers disposed longitudinally in the trailer and generally parallel with said roller tracks, with at least one of said plurality of sleepers disposed between adjacently disposed roller tracks.

8. The refrigerated trailer in accordance with claim 7 wherein said roller tracks are pneumatically actuated to raise rollers disposed in the roller tracks above the top surface of the roller tracks for loading of cargo into the refrigerated trailer.

9. The refrigerated trailer in accordance with claim 7 wherein said rollers disposed in the roller tracks recess below the top surface of the roller tracks when the pneumatic pressure is released such that the cargo rests upon the top surface of the roller tracks.

10. The refrigerated trailer in accordance with claim 7 wherein said sub floor consists of sheet metal.

11. The refrigerated trailer in accordance with claim 10 wherein said sheet metal has a thickness in the range of about ⅛ inch (0.32 cm) to about ½ inch (1.27 cm).

12. The refrigerated trailer in accordance with claim 7 wherein said upstanding sidewalls have reinforced panels disposed near the floor, and said sub floor is attached to said reinforced panels.

13. The refrigerated trailer in accordance with claim 7, said refrigerated trailer further comprising:
a refrigeration unit; and
a pair of ventilation ducts in communication with said refrigeration unit to provide refrigerated air from the refrigeration unit to the rear of the trailer, with one of said pair of ventilation ducts disposed along the ceiling adjacently to one sidewall of the trailer and the other of said pair of ventilation ducts disposed along the ceiling adjacently to the other sidewall of the trailer to provide maximum floor to ceiling height in a central area of the refrigerated trailer.

14. A refrigeration system for a refrigerated trailer, said refrigeration system comprising:
a refrigeration unit; and
a pair of ventilation ducts in communication with said refrigeration unit to provide refrigerated air from the refrigeration unit to the rear of the trailer, with one of said pair of ventilation ducts disposed along the ceiling adjacently to one sidewall of the trailer and the other of said pair of ventilation ducts disposed along the ceiling adjacently to the other sidewall of the trailer to provide maximum floor to ceiling height in a central area of the refrigerated trailer.
